(19) United States
(12) Patent Application Publication
(10) Pub. No.: US 2021/0017014 A1
(43) Pub. Date: Jan. 21, 2021

(54) Automatic Fuel Dispensing System

(71) Applicant: John Mouser, Rochester, MN (US)

(72) Inventor: John Mouser, Rochester, MN (US)

(21) Appl. No.: 16/931,798

(22) Filed: Jul. 17, 2020

Related U.S. Application Data
(60) Provisional application No. 62/875,615, filed on Jul. 18, 2019.

(51) Int. Cl. B67D 7/04; B67D 7/32

(52) U.S. Cl. CPC B67D 7/0401; B67D 7/3236; B67D 2007/0417; B67D 2007/0463; B67D 2007/0407; B67D 2007/0442; B67D 2007/0419

(57) ABSTRACT

An automatic fuel dispensing system is provided. The automatic fuel dispensing system includes an electronic terminal and a robotic arm. The electronic terminal houses a processor. The robotic arm is also controlled by the processor. The processor is programmed to perform a fueling program that will result in the refueling of an automobile. The fueling program provides a number of fuel options from which the user can select. When a fuel option is selected, a payment process is undergone, during which the customer pays for the refueling. Once the payment process is enacted, the fueling process is conducted. The fueling process causes the robotic arm to fuel the automobile.

### CROSS REFERENCE TO RELATED APPLICATIONS

This application claims the benefit of U.S. Provisional Application No. 62/875,615 filed on Jul. 18, 2019. The above identified patent application is herein incorporated by reference in its entirety to provide continuity of disclosure.

### BACKGROUND OF THE INVENTION

The present invention relates to an automatic fuel dispensing system. More specifically, the present invention relates to an automatic fuel dispensing system designed to assist users in the fueling of an automobile while minimizing physical interaction with a traditional fuel pumping system.

Automobiles have become an essential part of our transportation system and our daily lives. Since most automobiles are powered by gasoline, there is a need to refuel the gasoline at some point before the existing supply of gasoline has been exhausted. Traditionally, this process occurred at a gas station or similar location. Most gasoline refilling stations typically include a station terminal and a gasoline pump. The station terminal is traditionally configured to receive a payment from the user and to allow access to the gasoline pump. The gasoline pump includes an interface configured to engage the gasoline tank of the automobile being filled.

The process of pumping fuel into a vehicle, however, may be an unpleasant, difficult, or dangerous procedure. In the event of high and low temperatures, pumping fuel exposes the driver to these elements, as well as any extreme weather or precipitation. Exposure to these elements may be unpleasant or even dangerous, as these elements may cause medical problems or exacerbate underlying, medical conditions. Additionally, for individuals with disabilities, it can be difficult to reach and operate many fuel caps and fuel pump stations.

In addition to external risk factors, there are a number of inherent risks and inefficiencies with fuel pump stations. Users may spill gasoline onto the ground if they are not operating the fuel pump system with sufficient care. These spills not only can expose individuals to unhealthy fumes, but also contaminate the surrounding environment. Additionally, discharges of static electricity may cause danger to individuals in the area when they come into contact with gasoline fumes. Therefore, there is a defined need amongst the known arts for an automated fuel dispensing system that allows for safe and efficient fuel dispensing.

### SUMMARY OF THE INVENTION

In view of the foregoing disadvantages Inherent in the known types of fueling systems and fuel pump stations now present in the prior art, the present invention provides an automatic fuel dispensing system wherein the same can be utilized for providing convenience for the user when fueling an automobile.

The present system comprises an electronic terminal. The electronic terminal comprises a processor. The processor is programmed to perform a fueling program. The fueling program provides a plurality of fuel options for the user to select. When a fuel option is selected, a payment process is enacted. Once the payment process is enacted, the fueling process in conducted. The fueling process causes a robotic arm to fuel a vehicle. The robotic arm is in operable connection with the electronic terminal and the processor.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the automatic fuel dispensing system.

FIG. 2A shows a perspective view of an embodiment of a nozzle of the automatic fuel dispensing system.

FIG. 2B shows a perspective view of an embodiment of a nozzle of the automatic fuel dispensing system.

FIG. 2C shows a perspective view of an embodiment of a nozzle of the automatic fuel dispensing system.

FIG. 2D shows a perspective view of an embodiment of a nozzle of the automatic fuel dispensing system.

FIG. 3 shows a perspective view of an embodiment of the automatic fuel dispensing system.

### DETAILED DESCRIPTION OF THE INVENTION

Reference is made herein to the attached drawings. Like reference numerals are used throughout the drawings to depict like or similar elements of the automatic fuel dispensing system. The figures are intended for representative purposes only and should not be considered to be limiting in any respect.

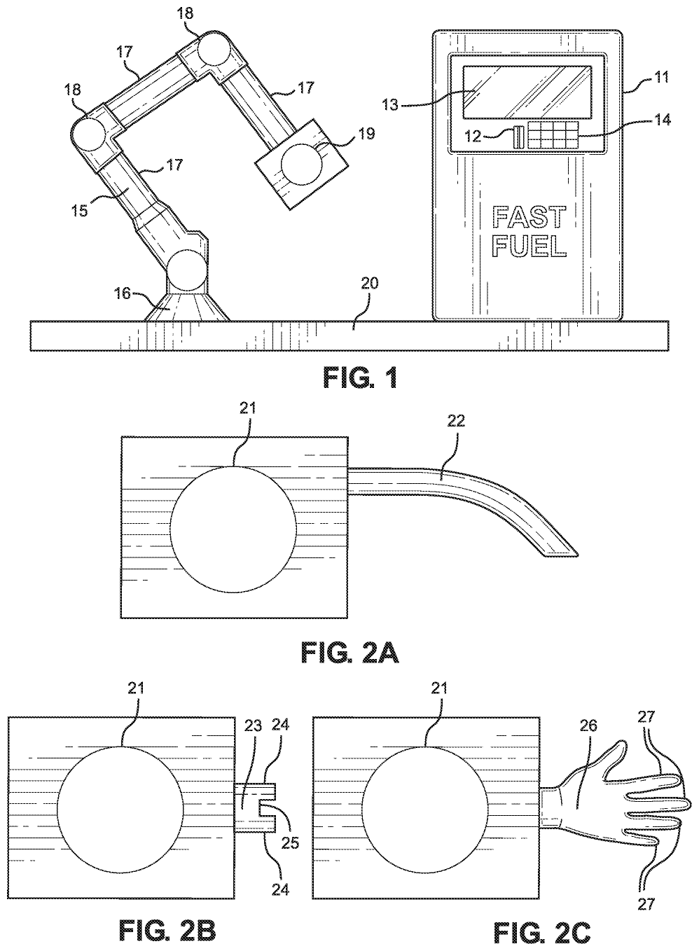

Referring now to FIG. 1, there is shown a perspective view of an embodiment of the automatic fuel dispensing system. The automatic fuel dispensing system comprises an electronic terminal 11. The electronic terminal 11 is the interface through which the customer interacts with the automatic fuel dispensing system. As such, the electronic terminal 11 comprises a mechanism through which to input data and a mechanism to enact the fueling process. The mechanism through which these mechanisms operate is a processor. The processor is configured to control and enact the fueling process.

In the illustrated embodiment, the electronic terminal 11 comprises a card reader 12. The card reader 12 is configured to receive a payment card, such as a credit card, a debit card, or a gift card. Furthermore, in the illustrated embodiment, the electronic terminal 11 comprises a screen 13. The screen 13 is configured to display visual and textual elements to the customer. In some embodiments, the screen 13 is a touchscreen. As such, the customer may input data into the electronic terminal 11 by touching elements of the touchscreen. Alternatively, in some embodiments of the automatic fuel dispensing system, the electronic terminal 11 comprises a plurality of buttons 14 on an external surface thereof. In such embodiments, the customer is able to input data to the electronic terminal 11 using the plurality of buttons 14. In some embodiments, the electronic terminal 11 comprises both a touchscreen and a plurality of buttons 14.

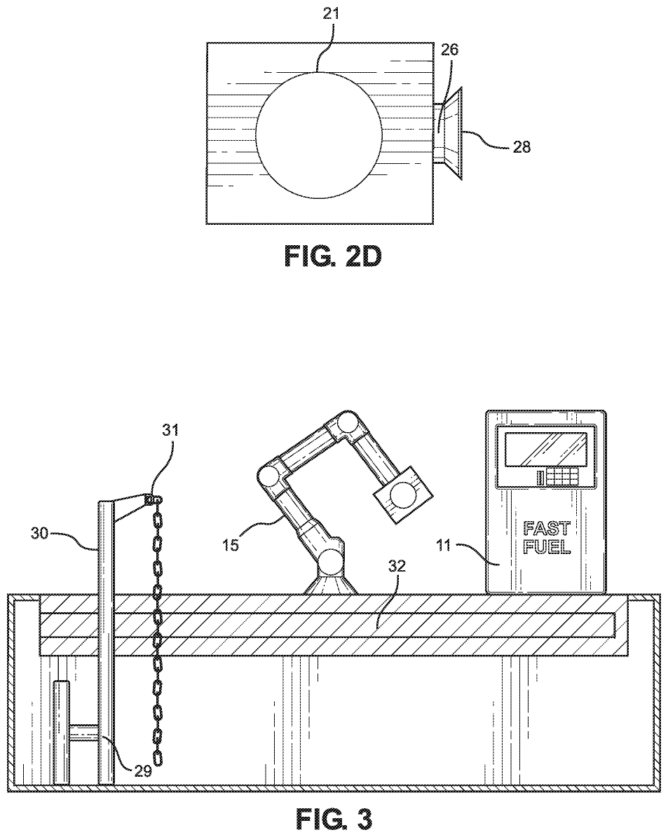

Additionally, the automatic fuel dispensing system comprises a robotic fuel arm 15. The robotic fuel arm 15 is configured to engage the fuel system of an automobile and to pump fuel into the fuel system. In the illustrated embodiment, the robotic fuel arm 15 comprises a base 16. The base 16 is configured to anchor the robotic fuel arm 15 to the surface on which the robotic fuel arm 15 is installed. Furthermore, the robotic fuel arm 15 comprises a plurality of segments 17 extending upward from the base 16. The plurality of segments 17 are connected via a plurality of rotatable joints 18. The plurality of rotatable joints 18 allow for movement of the robotic fuel arm 15 into a fueling position, wherein the robotic fuel arm 15 is capable of pumping fuel into the fuel system of the automobile. The plurality of segments 17 and the plurality of rotatable joints 18 define a channel to accommodate the flow of fuel therethrough. A nozzle 19 is disposed on the distal end of the robotic fuel arm 15. The nozzle 19 comprises a plurality of interfaces (shown in FIGS. 2A-2D). In some embodiments, the plurality of interfaces are interchangeable, such as to render the robotic fuel arm multifunctional. The robotic fuel arm 15 is made of any suitable material, such as aluminum, that increases the durability of the automatic fuel dispensing system.

The robotic fuel arm 15 is in operable connection with the processor and the electronic terminal 11. As such, the position and the function of the robotic fuel arm 15 is controllable via the processor. A sensor is in operable connection with the processor, such that the fuel cap and fuel interface of the automobile may be identified by the automatic fuel dispensing system. Furthermore, in some embodiments, a camera may be in operable connection with the processor to assist in identifying the location of the fueling interface of the automobile. In the illustrated embodiment, the electronic terminal 11 and the robotic fuel arm 15 are mounted upon a platform 20. The platform 20 provides stability to the automatic fuel dispensing system. Additionally, the platform 20 provides protection to any connection mechanisms between the robotic fuel arm 15 and the electronic terminal 11, as well as increasing the aesthetic appearance of the automatic fuel dispensing system.

The processor is configured to perform a fueling program. The fueling program provides a plurality of fuel options for a user to select. The fuel options may correspond to different types of fuel or gasoline with different octane ratings. Upon the selection of a fuel option, a payment process is performed. The payment process comprises any payment functionality, such as by credit card, debit card, gift card, cash, or check. Upon completion of the payment process, the payment process is performed. The fueling process enacts the robotic fuel arm 15 to fuel the automobile.

Referring now to FIG. 2A, there is shown a perspective view of an embodiment of a nozzle of the automatic fuel dispensing system. In the illustrated embodiment, the interface 21 comprises a fuel dispenser 22. The fuel dispenser 22 is configured to dispense fuel into the gas tank of the automobile. Structurally, the fuel dispenser comprises a tubular channel defined by an arcuate curve. As such, the fuel dispenser 22 can dispense fuel smoothly and effectively.

Referring now to FIG. 2B, there is shown a perspective view of an embodiment of a nozzle of the automatic fuel dispensing system. In the illustrated embodiment, the interface 21 of the nozzle comprises a fuel cap remover 23. The fuel cap remover 23 is configured to engage and remove the fuel cap of the automobile. Specifically, the fuel cap remover 23 comprises a pair of lateral protrusions 24 defining a space 25 therebetween. The space 25 is dimensioned to receive the handle of the fuel cap of the automobile, while the pair of lateral protrusions 24 apply rotational pressure to the fuel cap of the automobile. The fuel cap remover 23 is rotatably affixed to the nozzle, such as to rotate the gas cap.

Referring now to FIG. 2C, there is shown a perspective view of an embodiment of a nozzle of the automatic fuel dispensing system. In the illustrated embodiment, the interface 21 comprises a gas lid remover 26. Specifically, as shown, the gas lid remover 26 is structurally similar to a human hand having a plurality of finger portions 27, such as to provide dexterity in accessing the fuel system of the automobile. Automotive fuel systems commonly comprise systems of covers and doors to provide additional protection to the fuel system. By providing a dexterous and versatile interface, such as the interface shown, more functionality is provided to the robotic fuel arm.

Referring now to FIG. 2D, there is shown a perspective view of an embodiment of a nozzle of the automatic fuel dispensing system. In the illustrated embodiment, the interface 21 comprises a gas lid remover 26 having a flange 28. The flange 28 is configured to assist in the fueling process by allowing for removal of any manufacturer barriers between the fuel pump and the automobile fuel system.

Referring now to FIG. 3, there is shown a perspective view of an embodiment of the automatic fuel dispensing system. In the illustrated embodiment, the automatic fuel dispensing system comprises a grounding connection 29. The grounding connection 29 is configured to provide a connection between the earth and the automobile. As such, accidents involving the discharge of static electricity may be reduced or eliminated. In the illustrated embodiment, the grounding connection comprises a pole 30 and a metallic chain 31 in operable connection with the pole 30. As such, the metallic chain 31 may be attached to the automobile to prevent discharges of static electricity. In some embodiments, the grounding connection 29 is configured to automatically engage the automobile.

Furthermore, in the illustrated embodiment, the automatic fuel dispensing system comprises a metal grate 32 disposed adjacent to the electronic terminal 11 and the robotic fuel arm. The metal grate 32 is dimensioned to receive an automobile thereon. The metal grate 32 is configured to act as a reference for the customer when driving the automobile to the automatic fuel dispensing system, as well as to provide access to the underside of the automobile if necessary. Additionally, the metal grate 32 provides a drainage mechanism for spilled gasoline or other fluids.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An automatic fuel dispensing system, comprising:
an electronic terminal;
the electronic terminal comprising a processor;
a robotic fuel arm in operable connection with the processor;
the electronic terminal programmed to perform a fueling program;
the fueling program comprising the steps of:
providing a plurality of fuel options for a user to select;
upon the selection of a fuel option, performing a payment process;
upon completion of the payment process, performing a fueling process;
wherein the fueling process enacts the robotic, fuel arm to fuel a vehicle.

2) The automatic fuel dispensing system of claim 1, wherein the electronic terminal comprises a card reader.

3) The automatic fuel dispensing system of claim 1, further comprising a grounding connection, wherein the grounding connection is configured to ground the vehicle before, during, and after the fueling process.

4) The automatic fuel dispensing system of claim 3, wherein the grounding connection comprises a metallic chain.

5) The automatic fuel dispensing system of claim 1, wherein a nozzle is disposed on a distal end of the robotic fuel arm.

6) The automatic fuel dispensing system of claim 5, wherein the nozzle is interchangeable with a plurality of interfaces.

7) The automatic fuel dispensing system of claim 6, wherein the plurality of interfaces comprises at least one gas cap remover and at least one fuel dispenser.

8) The automatic fuel dispensing system of claim 6, wherein the plurality of interfaces is automatically interchangeable via the fueling program.

9) The automatic fuel dispensing system of claim 1, wherein the robotic fuel arm comprises a plurality of rotatable joints.

10) The automatic fuel dispensing system of claim 1, wherein the electronic terminal and the robotic fuel arm are mounted upon a platform.

11) The automatic fuel dispensing system of claim 1, wherein the electronic terminal comprises a touch screen.

12) The automatic fuel dispensing system of claim 1, wherein the electronic terminal further comprises a plurality of buttons thereon.

13) The automatic fuel dispensing system of claim 1, further comprising a camera in operable connection with the processor.

14) The automatic fuel dispensing system of claim 1, further comprising a metal grate disposed adjacent to the electronic terminal.
